(19) United States
(12) Patent Application Publication
(10) Pub. No.: US 2010/0202018 A1
(43) Pub. Date: Aug. 12, 2010

(54) IMAGE FORMING APPARATUS, POWER-SAVING CONTROL METHOD, AND COMPUTER-READABLE RECORDING MEDIUM HAVING RECORDED THEREIN POWER-SAVING CONTROL PROGRAM

(75) Inventors: Atsushi Akiyama, Shizuoka-ken (JP); Emiko Matsuoka, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/700,165

(22) Filed: Feb. 4, 2010

Related U.S. Application Data
(60) Provisional application No. 61/150,969, filed on Feb. 9, 2009.

(51) Int. Cl. G06F 1/32; G06F 3/12

(52) U.S. Cl. 358/1.15; 713/310; 713/324

(57) ABSTRACT

An image forming apparatus includes: a setting unit configured to cause a storage medium to store, among signals acquired via a network, a signal that is, if acquired, set as a trigger for execution of return processing for returning, from an energy saving state in which one or plural predetermined functions are halted, one or more of the halted functions to a usable state; a signal acquiring unit configured to acquire a signal via the network; a signal determining unit configured to determine whether the signal acquired by the signal acquiring unit is a signal stored as the signal set as the trigger for the return processing; and a function control unit configured to return, on the basis of the determination by the signal determining unit, the one or more of the halted functions to the usable state.

### CROSS-REFERENCE TO RELATED APPLICATION

This application is based upon and claims the benefit of priority from U.S. provisional application 61/150,969, filed on Feb. 9, 2009, the entire contents of each of which are incorporated herein by reference.

### TECHNICAL FIELD

This specification relates to a power saving technique for an image forming apparatus, and, more particularly to a technique for returning the image forming apparatus from a state in which power consumption is reduced to a normal operation state.

### BACKGROUND

Conventionally, an image forming apparatus connected to a network needs to be set in advance to return from a power saving mode in which power consumption is reduced to a non-power saving normal operation mode according to an event signal (a network event) transmitted from a computer or the like via the network. Concerning network events by communication methods other than unicast communication for transmitting data to a single specific partner in the network, the number of events that can be set as events to which the image forming apparatus is returned is limited. Usually, the setting of such events is fixed.

Therefore, when the image forming apparatus enters the power saving mode, the image forming apparatus often is not returned from the power saving mode according to a signal other than a unicast signal for a print job and the like. Even if there is possibility that functions of the image forming apparatus such as copying and facsimile are used after the signal transmission for the network events, the image forming apparatus has to be returned from the power saving mode when the functions are actually used. Therefore, for example, it takes time to return the image forming apparatus to the normal mode and efficiency of use is low.

### SUMMARY

In order to solve the problems, this specification relates to an image forming apparatus including: a setting unit configured to cause a storage medium to store, among signals acquired via a network, a signal that is, if acquired, set as a trigger for execution of return processing for returning, from an energy saving state in which one or plural predetermined functions are halted, one or more of the halted functions to a usable state; a signal acquiring unit configured to acquire a signal via the network; a signal determining unit configured to determine whether the signal acquired by the signal acquiring unit is a signal stored as the signal set as the trigger for the return processing; and a function control unit configured to return, on the basis of the determination by the signal determining unit, the one or more of the halted functions to the usable state.

This specification relates to a power-saving control method including: acquiring a signal via a network; determining whether the acquired signal is, among signals acquired via the network, a signal set in advance as a signal that is, if acquired, set as a trigger for execution of return processing for returning, from an energy saving state in which one or plural predetermined functions are halted, one or more of the halted functions to a usable state; and returning, on the basis of the determination, the one or more of the halted functions to the usable state.

This specification relates to a computer-readable recording medium having recorded therein a power-saving control program for causing a computer to execute processing for: acquiring a signal via a network; determining whether the acquired signal is, among signals acquired via the network, a signal set in advance as a signal that is, if acquired, set as a trigger for execution of return processing for returning, from an energy saving state in which one or plural predetermined functions are halted, one or more of the halted functions to a usable state; and returning, on the basis of the determination, the one or more of the halted functions to the usable state.

### DESCRIPTION OF THE DRAWINGS

FIG. 1 is a system diagram for explaining a system including an MFP as an image forming apparatus according to an embodiment of the present invention;

FIG. 2 is a functional block diagram of the MFP according to the embodiment;

FIG. 3 is a diagram of a setting screen for designating a protocol used as a trigger for, when acquired via a network, returning a device, a power supply for which is off, and designating a device (a function) that is returned, when a signal of the protocol is acquired, from a state in which a power supply for the device is off to an operation state;

FIG. 4 is a flowchart for explaining setting processing for performing return processing for returning the MFP from a power saving mode to a normal operation mode;

FIG. 5 is a flowchart for explaining a flow of the processing for return from the power saving mode;

FIG. 6 is a system diagram including an MFP according to a second embodiment of the present invention; and

FIG. 7 is a functional block diagram for explaining a function of executing processing for return from a power saving mode by an MFP according to a third embodiment of the present invention.

### DETAILED DESCRIPTION

Embodiments of the present invention are explained below with reference to the accompanying drawings.

### First Embodiment

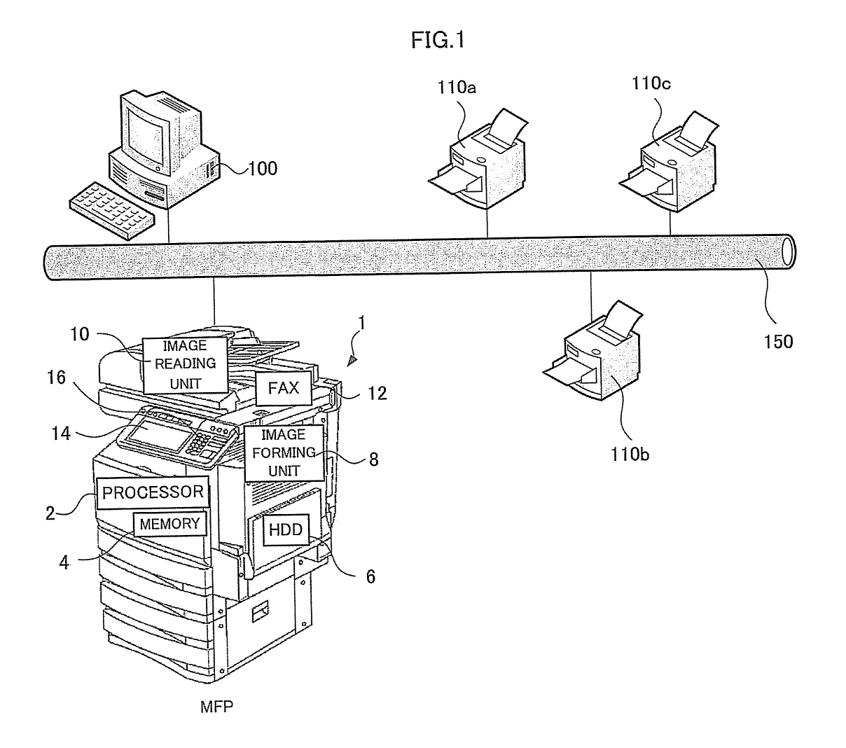

FIG. 1 is a system diagram for explaining a system including an MFP (Multi Function Peripheral) 1 as an image forming apparatus according to a first embodiment of the present invention.

The system according to this embodiment includes the MFP 1, a computer 100, and other MFPs (or printers) 110a to 110c. The MFP 1, the computer 100, and the other MFPs (or the printers) 110a to 110c are connected via a network 150.

The MFP 1 according to this embodiment has a function of returning, when the MFP 1 operates in a power saving mode in which operation states of devices such as an HDD (Hard Disc Drive) 6, a facsimile 12, and a display screen 14 are switched to a state of low power consumption compared with a normal operation mode (hereinafter also referred to as power saving mode), if a predetermined signal is acquired from, for example, the computer 100 connected to the MFP 1 via the network 150, an operation state of a device set in advance corresponding to the signal to the normal operation state. When the MFP 1 according to this embodiment operates in the power saving mode in which, for example, power supplies for the devices including the HDD 6 are off, the MFP 1 turns on, if the predetermined signal is acquired via the network 150, the power supply for the HDD 6 with the signal as a trigger. After a signal transmitted to plural apparatuses (a signal in broadcast or multicast) other than a signal in unicast with the MFP 1 set as a transmission destination is acquired as the predetermined signal, if it is highly likely that the HDD 6 is used in relation to the signal, the power supply for the HDD 6 can be set to be turned on as explained above. This makes it possible to return the MFP 1 to a normal operation state before the use of the HDD 6. Therefore, even if the MFP 1 operates in the power saving mode, the MFP 1 can be immediately used. It is possible to reduce waiting time until normal use of the MFP 1 can be performed from the power saving mode.

The MFP 1 according to this embodiment is characterized in that a user can arbitrarily set a signal (or a type of the signal) that is set as a trigger for switching an operation state when acquired by the MFP 1 and can also arbitrarily set a function (a device) that is returned to the normal state when the signal is acquired. For example, as explained later, when a signal in an ARP protocol is transmitted by broadcast from the computer 100 to the MFP 1, the other MFPs 110a to 110c, and the like via the network 150 and the MFP 1 acquires the signal, the user can designate which of the power supplies for the HDD 6, the facsimile 12, the display screen 14, and the like, which are set in the power saving mode and the power supplies for which are off, is turned on. For example, after the signal in the ARP protocol is acquired, when the HDD 6 and the display screen 14 are actually used by the user but the facsimile 12 is not used, the signal in the ARP protocol can be designated to return only the HDD 6 and the display screen 14 to a normal operation state. This makes it possible to switch an optimum power saving mode and the normal operation mode according to a state of use.

The configuration of the MFP 1 according to this embodiment is explained in detail below. In the following explanation, the power saving mode is a state in which the power supply for any one of the devices included in the MFP 1 is off. Return processing to normal operation is explained as processing for turning on the turned-off power supply for any one of the devices. However, the present invention is not limited to this. This embodiment can be applied in the same manner to any return processing from the power saving mode such as processing for return the MFP 1 from a state in which power consumption is lower than that in the normal operation state to the normal operation state.

The MFP 1 includes a processor 2, a memory 4, the HDD 6, an image forming unit 8, an image reading unit 10, the facsimile 12, the display screen 14, and an operation input unit 16.

The processor 2 controls various kinds of processing in the MFP 1. In this embodiment, the MFP 1 executes processing for turning on a power supply for at least one of the devices, power supplies for which are off, from the power saving mode in which a power supply for any one of the devices is off (processing for returning from the power saving mode). The processor 2 can also execute various computer programs stored in the memory 4. The processor 2 can include a CPU (Central Processing Unit) or a MPU (Micro Processing Unit).

The memory 4 stores computer programs used for processing such as printing, scanning, and facsimile in the MFP 1. In this embodiment, the memory 4 stores a computer program used for the return processing from the power saving mode. The memory 4 can include a RAM (Random Access Memory), a ROM (Read Only Memory), a DRAM (Dynamic Random Access Memory), an SRAM (Static Random Access Memory), or a VRAM (Video PAM).

The HDD 6 stores various data such as image data obtained by scanning an original document with the image reading unit 10 and bitmap data generated in printing.

The image forming unit 8 performs, using image data read from an original document by the image reading unit 10 or image data acquired from a recording medium such as a flash memory directly connected to the MFP 1 or an external apparatus connected to the MFP 1 via the network 150, processing for forming an image on a sheet such as a copy sheet, thick paper, or an OHP film.

The image reading unit 10 is a general image reading device included in a copying machine, an image scanner, or the like. The image reading unit 10 is used in copying an original document or scanning the original document using the MFP 1.

The facsimile 12 is a device configured to transmit and receive facsimile signals in the MFP 1.

The display screen 14 displays various kinds of information such as setting information and an operation state of the MFP 1. In this embodiment, the display screen 14 displays a setting screen for the return processing from the power saving mode explained later. The display screen 14 can include an LCD (Liquid Crystal Display), an EL (Electronic Luminescence), a PDP (Plasma Display Panel), or a CRT (Cathode Ray Tube). When the display screen 14 includes a touch panel display, the display screen 14 can also realize a part or all of the functions of the operation input unit 16.

The operation input unit 16 performs operations for designating conditions for copying and scanning and for inputting a facsimile number. The operation input unit 16 also performs operation input for performing setting for the return processing from the power saving mode. The operation input unit 16 can include input keys for numbers and the like, a keyboard, a mouse, a touch panel, a touch pad, or a graphics tablet.

Setting concerning the return processing from the power saving mode of the MFP 1 and the return processing based on the setting are explained below.

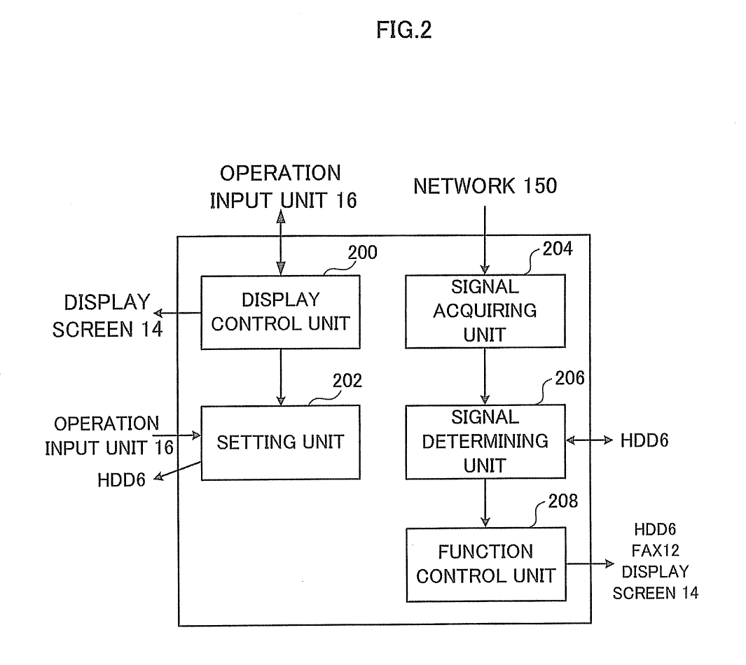

FIG. 2 is a functional block diagram of the MFP 1 according to this embodiment. The MFP 1 includes a display control unit 200, a setting unit 202, a signal acquiring unit 204, a signal determining unit 206, and a function control unit 208.

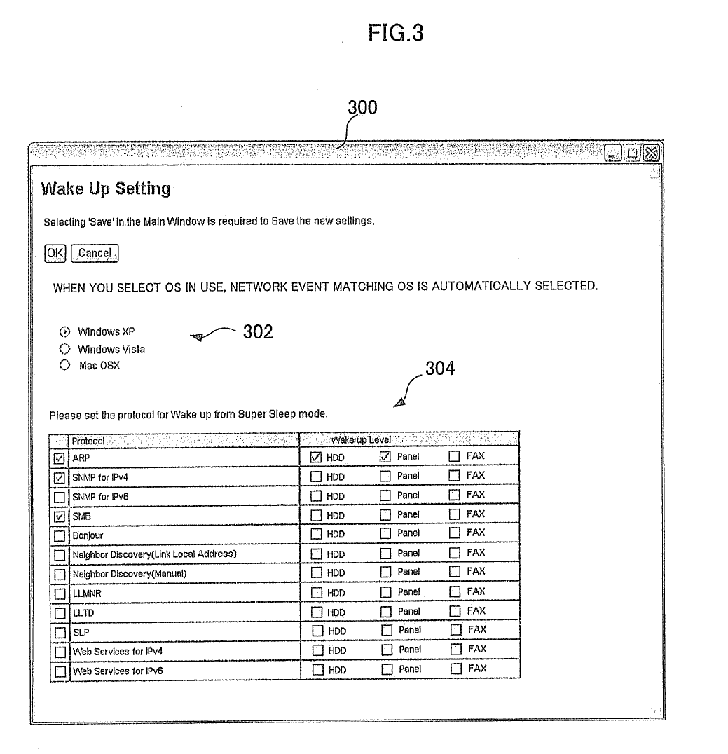

The display control unit 200 displays, according to operation of the operation input unit 16, a setting screen for setting details of the return processing from the power saving mode to the normal operation state. FIG. 3 is a diagram of a setting screen 300 for designating a protocol used as a trigger for, when a signal is acquired, executing the return processing from the power saving mode among protocols of signals acquired by the MFP 1 via the network 150 and designating a device (a function) that is returned, when the signal of the protocol is acquired, from a state in which a power supply is off to a state in which the power supply is on.

First, in an OS designation space 302, an operation system (OS) as an environment in which the MFP 1 is used can be designated.

A return processing setting list (hereinafter also referred to as setting list) 304 in which protocols suitable for OSs (used in the OSs), which are likely to be received by the MFP 1, are listed is displayed on the basis of the designation in the OS designation space 302. In the setting list 304 shown in FIG. 3, Windows XP (a registered trademark) is selected as an OS, whereby ARP, SNMP for IPv4, SNMP for IPv6, SMB, Bonjour, Neighbor Discovery, LLMNR, LLTD, SLP, Web Service for IPv4, and Web Service for IPv6 are displayed as protocols in a protocol designation space. A designation space for devices that are returned from the power saving mode to the normal operation according to reception of a signal is displayed on the right side of the protocol space. As an example, the HDD 6, the display screen (panel) 14, and the facsimile 12 are shown.

In such a setting list, for example, in FIG. 3, a checkbox for ARP in the protocol designation space is checked. Checkboxes for the HDD 6 and the display screen 14 (in FIG. 3, “Panel”) are checked in the designation space for the devices. Therefore, when the return processing is set under this condition, if the MFP 1 acquires a signal of an ARP protocol in a state in which the devices including the HDD 6 and the display screen 14 operate in the power saving mode in which the power supplies therefor are off, processing for turning on the power supplies for the HDD 6 and the display screen 14 is performed.

Subsequently, when details of the return processing are designated in the setting screen 300 according to operation of the operation input unit 16, the setting unit 202 performs processing for causing the HDD 6 to store setting information including the designated information. Specifically, the setting unit 202 causes the HDD 6 to store, in association with each other, a protocol, a checkbox for which is checked, and information indicating a device designated by checking the checkbox for the protocol.

The above is the explanation of the functional blocks for executing the setting processing for setting the details of the return processing.

Functional blocks for actually executing the return processing on the basis of the setting processing are explained below.

First, the signal acquiring unit 204 acquires some signal via the network 150.

The signal determining unit 206 determines, referring to the setting information stored in the HDD 6, whether the signal acquired by the signal acquiring unit 204 is designated as a signal as a trigger for executing the return processing and determines, if the acquired signal is designated as the signal as the trigger, which of the devices is designated as being returned from the power saving mode.

When the signal determining unit 206 determines that the acquired signal is designated as the signal as the trigger for executing the return processing, the function control unit 208 performs processing for turning on the power supply for the device that is returned from the power saving mode to the normal operation. For example, when the return processing is set as shown in FIG. 3, if the acquired signal is the ARP protocol, the function control unit 208 performs processing or turning on the power supplies for the HDD 6 and the display screen 14.

The above is the explanation of the functional blocks for executing the return processing.

The function of setting the details of the return processing and the function of executing the return processing are realized by the processor 2 executing the computer program stored in the memory 4.

With the MFP 1 according to this embodiment having the configuration explained above, even when a signal is transmitted to the MFP 1 by multicast or broadcast in the state of the power saving mode, it is possible to turn on, with the signal as a trigger, a power supply of a device designated in advance. Therefore, even after the MFP 1 enters the power saving mode, since the power supply for the device (the function) is turned on according to acquisition of the signal set in advance, the MFP 1 can quickly use the function. Therefore, it is possible to reduce waiting time until the MFP 1 returns from the power saving mode to the normal operation state.

The user can arbitrarily designate a type (a protocol, etc.) of a signal for turning on a power supply for a device and a device, a power supply for which is turned on when the signal is acquired. Therefore, it is possible to execute optimum return processing according to a state of use of the MFP 1. Since a signal for executing the return processing for a device can be designated according necessity in this way, even if a signal with low necessity for returning a device to the normal operation state is acquired, the return processing is not executed. Therefore, it is possible to reduce power consumption.

Flows of the setting processing for performing the return processing and the return processing based on the setting in the MFP 1 according to this embodiment are explained below.

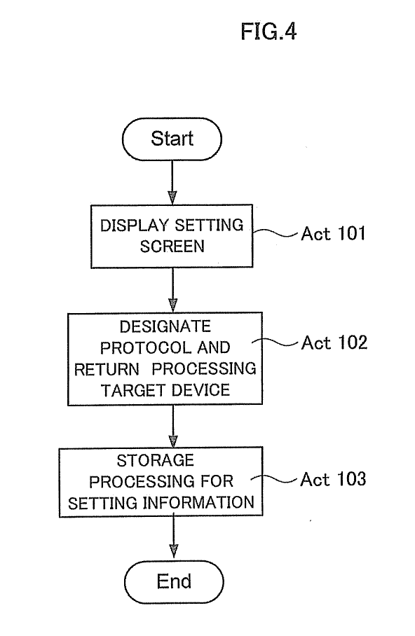

FIG. 4 is a flowchart of the setting processing for performing the return processing from the power saving mode to the normal operation state.

First, in Act 101, when the user performs operation input from the operation input unit 16 to perform the setting processing for setting the return processing, the display control unit 200 performs processing for displaying the setting screen shown in FIG. 3 on the display screen 14.

In Act 102, the user operates the operation input unit 16 while looking at the displayed setting screen and designates an OS, a protocol that is designated as a trigger for the return processing, and a device that is returned to the normal operation state when the protocol is received.

When the user decides the designation, in Act 103, the setting unit 202 performs processing for causing the HDD 6 to store information concerning the setting. Specifically, as shown in FIG. 3, the user designates a necessary protocol such as ARP, designates a device, a power supply for which is switched from OFF to ON when a signal of the protocol is received, and decides the designation. Then, the setting unit 202 causes the HDD 6 to store, in association with each other, the protocol and information for designating the device that is returned to the normal operation state.

The above is the explanation of the flow of the processing for setting the return processing.

A flow of processing for returning the MFP 1 from the power saving mode on the basis of the setting stored by the processing explained above is explained.

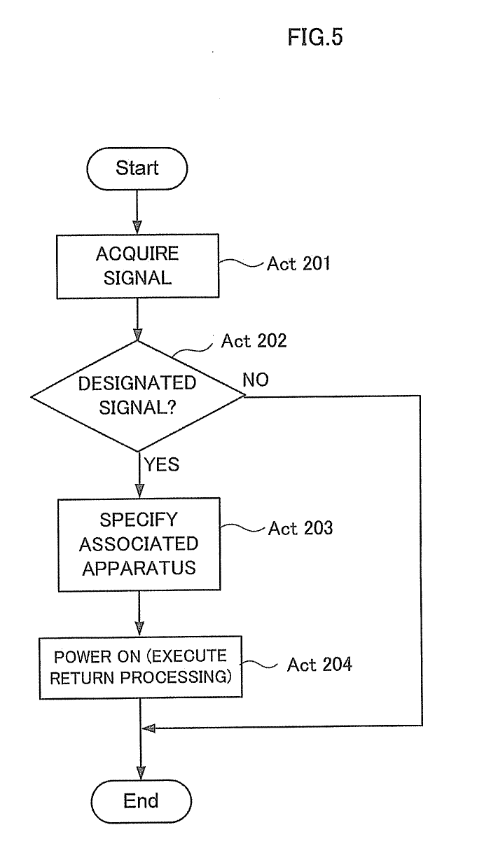

FIG. 5 is a flowchart for explaining the flow of the return processing.

First, in Act 201, the signal acquiring unit 204 acquires a signal via the network 150.

Subsequently, in Act 202, the signal determining unit 206 performs determination processing for the signal acquired by the signal acquiring unit 204. Specifically, the signal determining unit 206 determines, referring to the setting information concerning the return processing stored in the HDD 6, whether the acquired signal is a type (“protocol” in this embodiment) of a signal designated as a trigger for return from the power saving mode.

If it is determined in Act 202 that the acquired signal is the signal designated as the trigger for return from the power saving mode, in Act 203, the signal determining unit 206 specifies, on the basis of the setting information, a device associated with the signal (the protocol) that is returned to the normal operation.

On the other hand, if it is determined in Act 202 that the acquired signal is a signal not designated as the trigger for the return processing in the setting information, the signal determining unit 206 ends the processing without performing the return processing.

In Act 204, the function control unit 208 turns on a power supply for the device, which should be returned to the normal operation mode, specified by the signal determining unit 206 in Act 203 and returns the device from the power saving mode.

The above is the explanation of the flow of the return processing based on the setting information.

In the return processing, if the signal acquired by the MFP 1 is a unicast signal transmitted with an address of the MFP 1 designated, the MFP 1 returns the MFP 1 from the power saving mode to the normal operation state without performing the determination processing based on the setting information by the signal determining unit 206. This is because, usually, since the unicast signal is transmitted to use the functions of the MFP 1, the MFP 1 only has to be returned to the normal operation even if it is not determined whether the return processing is performed.

With the MFP 1 according to this embodiment, when a signal of multicast or broadcast is acquired, a power supply for an arbitrary device included in the MFP 1 can be turned on according to a state of use of the MFP 1. Therefore, at a stage when the signal of multicast or the like is received, a power supply for a device that is likely to be used after that stage is turned on. This makes it possible to use the functions of the MFP 1 without waiting for return to the normal operation state when the device is actually used.

Since an apparatus that is returned to the normal operation state can be arbitrarily set for each of types (protocols) of signals, it is possible to turn on a power supply for only a necessary device. Therefore, compared with a case in which the power supplies for all the devices are collectively turned on from the power saving mode, it is possible to further reduce power consumption.

### Second Embodiment

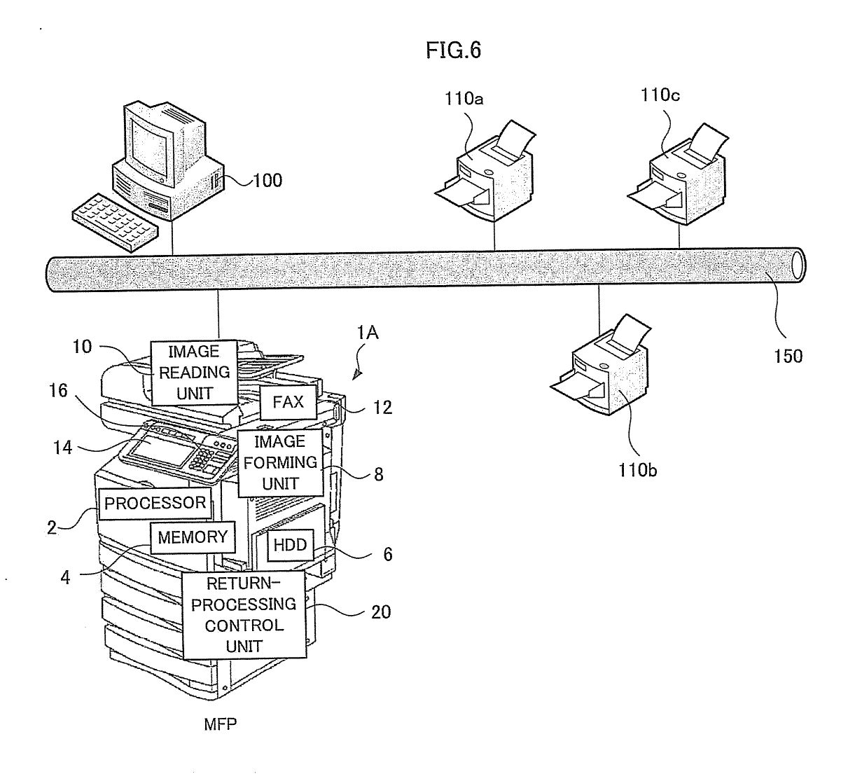

An MFP 1A according to a second embodiment of the present invention includes, as shown in FIG. 6, separately from the processor 2 and the memory 4, a power-saving control unit 20 configured to exclusively controls the functions of the signal acquiring unit 204, the signal determining unit 206, and the function control unit 208 for executing the return processing shown in FIG. 2. FIG. 6 is a system diagram including the MFP 1A according to this embodiment. The MFP 1A according to this embodiment is explained below. However, components same as those of the MFP 1 according to the first embodiment are denoted by the same reference numerals and signs and redundant explanation of the components is omitted.

As explained above, the MFP 1A according to this embodiment further includes the power-saving control unit 20 configured to exclusively execute only the return processing from the power saving mode based on the setting information. When the power-saving control unit 20 acquires some signal via the network 150, the power-saving control unit 20 can execute return processing same as that in the first embodiment with the functions of the signal acquiring unit 204, the signal determining unit 206, and the function control unit 208 of the power-saving control unit 20.

However, in the case of this embodiment, the power-saving control unit 20 executes the processing for acquiring a signal, determining that a device, a power supply for which is off, is turned on, and turning on the power supply. Therefore, the power supplies for the processor 2, the memory 4, and the like can also be set off. As a result of the determination of the acquired signal, if it is determined that a power supply for some device is turned on, the function control unit 208 of the power-saving control unit 20 can turn on the power supplies for the processor 2 and the memory 4 and further turn on a power supply for a device corresponding to the acquired signal on the basis of the stored setting information.

With such a configuration of this embodiment, even if the power supplies for the processor 2, the memory 4, and the like are turned off in the power saving mode, the return processing from the power saving mode of the present invention can be executed. Therefore, it is possible to further reduce power consumption in the power saving mode.

### Third Embodiment

The MFP 1 according to a third embodiment of the present invention includes, as a function concerning the return processing from the power saving mode, an optimization processing unit 210 replacing the setting unit 202 or used together with the setting unit 202.

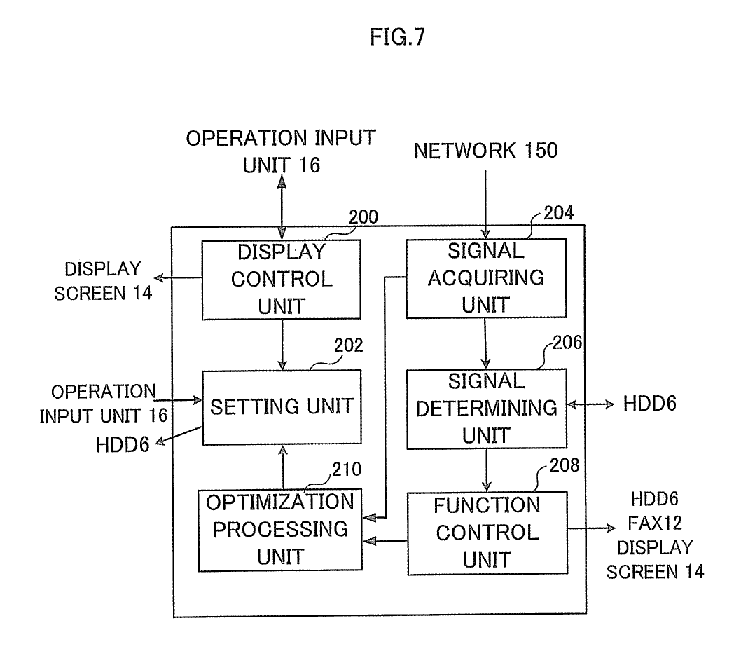

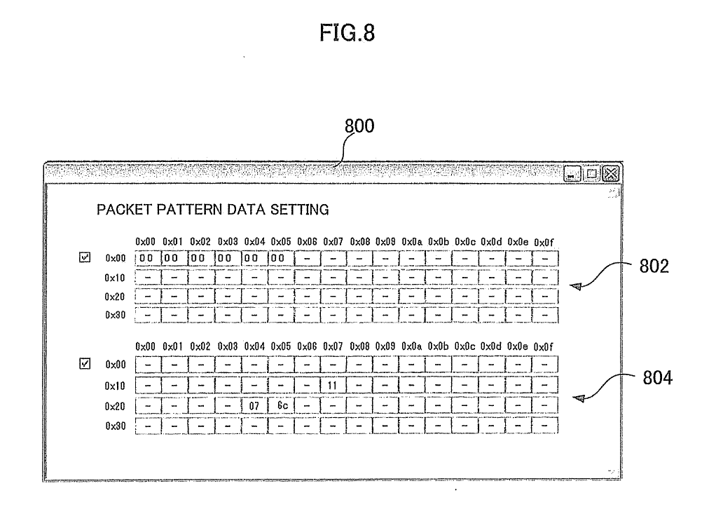

FIG. 7 is a functional block diagram for explaining a function of executing the return processing from the power saving mode by the MFP 1 according to this embodiment.

The optimization processing 210 included in the MFP 1 according to this embodiment performs processing for collecting, for example, information concerning a signal acquired by the MFP 1 and a device actually used in relation to the signal after the acquisition of the signal and optimizing the setting information shown in FIG. 3. Specifically, when an actual state of use of the MFP 1 and designation in the setting information does not match, the optimization processing unit 210 optimizes the setting information according to the actual state of use. For example, the optimization processing unit 210 performs the optimization processing when the acquired signal is a signal designated in designation processing for a signal (a protocol) for performing the return processing from the power saving mode and the return processing is performed on the basis of the designation according to the functions of the signal determining unit 206 and the function control unit 208 but, actually, a frequency of use of the functions after the signal acquisition is low. Conversely, the optimization processing unit 210 also performs the optimization processing when the acquired signal is a signal not designated in the designation processing but a frequency of use of a specific function (e.g., the HDD 6 or the facsimile 12) after the signal acquisition is high.

Examples of the information collected by the optimization processing unit 210 include information concerning, for example, the number of times the signal acquiring unit 204 acquires signals excluding unicast and the function control unit 208 turns on the power supplies for the devices of the MFP 1 on the basis of the signals, information concerning whether the turned-on devices are actually used incidentally to reception of a designated signal after the devices are turned on, and information concerning a frequency of, when the signal acquiring unit 204 acquires a signal not designated as a trigger for the return processing, using the devices after the acquisition of the signal.

With the MFP 1 according to this embodiment, setting information arbitrarily set by a user can be optimized according to a state of use after the setting. Therefore, when the MFP 1 executes the return processing from the power saving mode, since a power supply for a device is turned on only when necessary, it is possible to further reduce power consumption.

In the explanation of the first to third embodiments, the setting processing for performing the return processing is displayed on the display screen 14 of the MFP 1 (1A) and performed. However, the present invention is not limited to this. It is also possible to display a setting screen for performing the setting processing for the return processing in another computer connected to the MFP 1 (1A) via the network 150 and perform, from the computer, setting of the return processing.

In the explanation of the embodiments, in the setting information, it is designated for each of the protocols whether the return processing is performed. However, the present invention is not limited to this. It is possible not only to set the return processing for each of the protocols but also set the return processing to be executed concerning an arbitrary signal. For example, when it is likely that a specific function of the MFP is used after a signal of a specific type is received, if the return processing for the function is set to be executed after the reception of the signal, it is possible to quickly use the function.

The determination concerning whether the return processing is performed in this case can be executed by, for example, determining whether a data pattern (a data array, data content, a method of storing data, etc.) of received packet data coincides with a data pattern set to execute the return processing in advance. Specifically, when, in a signal desired to be set to execute the return processing, packet data having a data pattern that can specify the signal is present, the pattern data is stored in advance in the MFP. When packet data coinciding with the set data pattern is present in data received by the MFP, the return processing set in advance can be executed.

In FIG. 8, an example of a setting screen displayed when the setting of the return processing is performed according to a data pattern is shown. In a packet data list 802 of a setting screen 800, as an example, data patterns that can designate values of bytes up to 64 bytes are shown as data patterns set to execute the return processing. For example, in the case of the packet data list 802 shown in FIG. 8, a data pattern in which bytes of 0, 1, 2, 3, 4, and 5 in a hexadecimal digit (in a table shown in FIG. 8, 0x00 to 0x05) are “00” is designated as packet data for executing the return processing. Specifically, when data patterns are designated as shown in the packet data list 802, when the MFP receives packet data having a data pattern in which values of 0x00 to 0x05 are “00”, the MFP executes the return processing. (In the setting of the packet data list 802, matching for determining whether the return processing is executed is not performed for bytes indicated by “-” other than 0x00 to 0x05.)

By performing the setting of the return processing according to a data pattern in this way, it is possible to designate, irrespectively of a protocol, an arbitrary signal as a signal for executing the return processing. Therefore, when a signal of a type desired to be designated to execute the return processing is present but it is unnecessary to perform the return processing for all signals for using a protocol corresponding to the signal, it is possible to separately designate a signal for executing the return processing. By setting the return processing in this way, it is possible to perform more detailed return processing setting. Therefore, it is possible to execute the return processing only when a signal requiring the return processing is received and further improve a power saving effect.

As a method of setting the return processing, it is also possible to designate, using a data pattern of packet data as explained above, a protocol for executing the return processing. A packet data list 804 shown in FIG. 8 is an example in which it is designated to execute the return processing when the MFP receives a signal by an SSDP (Simple Service Discovery Protocol) of a UDP (User Datagram Protocol) as a protocol of a signal for executing the return processing. In this data pattern, a value “11” of byte of 0x17 means that a protocol is the UDP. Values of 0x24 and 0x25 designate a lower order protocol of the UDP. In the case of the packet data list 804, since 0x24 is “07” and 0x25 is “6c”, it is seen that the protocol designates a port number 1900. Since the port number is “1900” in this way, it is specified that the packet data is transmitted according to a protocol of the SSDP. Therefore, by designating the data pattern for executing the return processing as shown in the packet data list 804, when packet data of a protocol of the SSDP of the UDP is received, the return processing is executed. In this way, it is possible to designate, using a data pattern, a protocol for performing the return processing. This makes it possible to designate, as a trigger for the return processing, for example, a protocol not displayed in the protocol list shown in FIG. 3.

Further, a computer program for causing a computer included in the MFP (the image forming apparatus) to execute the operations explained above can be provided as a power-saving control program. In the example explained in this embodiment, the computer program for realizing the function of carrying out the invention is recorded in advance in a storage area provided in the apparatus. However, the present invention is not limited to this. The same computer program may be downloaded from a network to the apparatus. The same computer program stored in a computer-readable recording medium may be installed in the apparatus. A form of the recording medium may be any form as long as the recording medium is a recording medium that can store the computer program and can be read by the computer. Specifically, examples of the recording medium include internal storage devices internally mounted in the computer such as a ROM and a RAM, portable storage media such as a CD-ROM, a flexible disk, a DVD disk, a magneto-optical disk, and an IC card, a database that stores a computer program, other computers and databases therefor, and a transmission medium on a line. A function obtained by installation or download in advance in this way may be realized in cooperation with an OS (operating system) or the like in the apparatus.

The computer program may be an execution module that is dynamically generated partially or entirely.

The present invention can be carried out in various forms without departing from the spirit or the main characteristic thereof. Therefore, the present invention is only an illustration in every aspect and should not be limitedly interpreted. The scope of the present invention is indicated by the scope of claims and is by no means limited by the text of the specification. Further, all modifications and various improvements, substitutions, and alterations belonging to the scope of equivalents of the scope of claims are within the scope of the present invention.

As explained above, according to the present invention, it is possible to provide a technique for enabling quick shift from a power saving state to a usable state of an image forming apparatus while realizing energy saving for the image forming apparatus.

What is claimed is:

1. An image forming apparatus comprising:
a setting unit configured to cause a storage medium to store, among signals acquired via a network, a signal that is, if acquired, set as a trigger for execution of return processing for returning, from an energy saving state, in which one or plural predetermined functions are halted, one or more of the halted functions to a usable state;
a signal acquiring unit configured to acquire a signal via the network;
a signal determining unit configured to determine whether the signal acquired by the signal acquiring unit is a signal stored as the signal set as the trigger for the return processing; and
a function control unit configured to return, on the basis of the determination by the signal determining unit, the one or more of the halted functions to the usable state.

2. The apparatus according to claim 1, further comprising a display control unit configured to cause a display screen to display a setting screen for designating a signal set as a trigger for the return processing and a function returned to the usable state according to the signal, wherein
the setting unit causes the storage medium to store, in association with each other, the signal and the function designated in the setting screen.

3. The apparatus according to claim 2, wherein the function control unit returns the function stored by the setting unit in association with the signal to the usable state.

4. The apparatus according to claim 1, wherein
the setting unit causes the storage medium to store a protocol of the signal set as the trigger for the return processing, and
the signal determining unit determines whether the signal acquired by the signal acquiring unit is the signal in accordance with the protocol that the setting unit causes the storage medium to store.

5. The apparatus according to claim 1, wherein the signal acquired via the network is a signal transmitted by broadcast or multicast.

6. The apparatus according to claim 2, wherein the display control unit displays a signal matching an environment in which the image forming apparatus is used.

7. The apparatus according to claim 3, further comprising an optimization processing unit configured to change, on the basis of the signal acquired via the network and a state of use of a function related to the acquisition of the signal, the information stored in the storage medium by the setting unit.

8. The apparatus according to claim 1, wherein
the setting unit causes the storage medium to store a data pattern of packet data that is the signal set as the trigger for the return processing, and
the signal determining unit determines whether the data pattern of the packet data, which is the signal acquired by the signal acquiring unit, is a data pattern that the setting unit causes the storage medium to store.

9. A power-saving control method comprising:
acquiring a signal via a network;
determining whether the acquired signal is, among signals acquired via the network, a signal set in advance as a signal that is, if acquired, set as a trigger for execution of return processing for returning, from an energy saving state in which one or plural predetermined functions are halted, one or more of the halted functions to a usable state; and
returning, on the basis of the determination, the one or more of the halted functions to the usable state.

10. The method according to claim 9, further comprising causing the storage medium to store, among the signals acquired via the network, the signal as the signal that is, if acquired, set as the trigger for execution of the return processing for returning, from the energy saving state in which one or plural predetermined functions are halted, one or more of the halted functions to the usable state.

11. The method according to claim 10, further comprising:
causing a display screen to display a setting screen for designating a signal set as a trigger for the return processing and a function returned to the usable state according to the signal; and
causing the storage medium to store, in association with each other, the signal and the function designated in the setting screen.

12. The method according to claim 11, further comprising returning the function stored in association with the signal to the usable state.

13. The method according to claim 10, further comprising:
causing the storage medium to store a protocol of the signal set as the trigger for the return processing; and
determining whether the acquired signal is the signal in accordance with the protocol that the storage medium is caused to store.

14. The method according to claim 10, further comprising:
causing the storage medium to store a data pattern of packet data that is the signal set as the trigger for the return processing; and
determining whether the data pattern of the packet data, which is the acquired signal, is a data pattern that the storage medium is caused to store.

15. The method according to claim 12, further comprising changing, on the basis of the signal acquired via the network and a state of use of a function related to the acquisition of the signal, the information stored in the storage medium.

16. A computer-readable recording medium having recorded therein a power-saving control program for causing a computer to execute processing for:
acquiring a signal via a network;
determining whether the acquired signal is, among signals acquired via the network, a signal set in advance as a signal that is, if acquired, set as a trigger for execution of return processing for returning, from an energy saving state in which one or plural predetermined functions are halted, one or more of the halted functions to a usable state; and
returning, on the basis of the determination, the one or more of the halted functions to the usable state.

17. The recording medium according to claim 16, wherein the power-saving control program further causes the computer to execute processing for causing the storage medium to store, among the signals acquired via the network, the signal as the signal that is, if acquired, set as the trigger for execution of the return processing for returning, from the energy saving state in which one or plural predetermined functions are halted, one or more of the halted functions to the usable state.

18. The recording medium according to claim 17, wherein the power-saving control program further causes the computer to execute processing for:
causing a display screen to display a setting screen for designating a signal set as a trigger for the return processing and a function returned to the usable state according to the signal; and
causing the storage medium to store, in association with each other, the signal and the function designated in the setting screen.

19. The recording medium according to claim 17, wherein the power-saving control program further causes the computer to execute processing for:
causing the storage medium to store a protocol of the signal set as the trigger for the return processing; and
determining whether the acquired signal is the signal in accordance with the protocol that the storage medium is caused to store.

20. The recording medium according to claim 17, wherein the power-saving control program further causes the computer to execute processing for:
causing the storage medium to store a data pattern of packet data that is the signal set as the trigger for the return processing; and
determining whether the data pattern of the packet data, which is the acquired signal, is a data pattern that the storage medium is caused to store.
